(19) United States
(12) Patent Application Publication
(10) Pub. No.: US 2026/0029571 A1
(43) Pub. Date: Jan. 29, 2026

(54) SINGLE-MODE, HOLLOW-CORE OPTICAL FIBERS

(71) Applicant: CORNING INCORPORATED, CORNING, NY (US)

(72) Inventors: Paulo Clovis Dainese, Jr., Painted Post, NY (US); Klaus Hartkorn, Painted Post, NY (US); Ming-Jun Li, Horseheads, NY (US); Dan Trung Nguyen, Painted Post, NY (US); Ilia Andreyevich Nikulin, Leland, NC (US)

(21) Appl. No.: 19/269,664

(22) Filed: Jul. 15, 2025

Related U.S. Application Data
(60) Provisional application No. 63/675,953, filed on Jul. 26, 2024.

(51) Int. Cl. G02B 6/02; G02B 6/036

(52) U.S. Cl. CPC G02B 6/02304; G02B 6/036

(57) ABSTRACT

A hollow-core optical fiber that includes an outer cladding having a tubular shape with a hollow interior, a plurality of inner cladding members positioned with the hollow interior and a hollow core formed by the plurality of inner cladding members. The hollow-core optical fiber is configured to provide single-mode propagation of an optical signal within a wavelength range from 800 nm to 2000 nm.

This application claims the benefit of priority to U.S. Provisional Patent Application Ser. No. 63/675,953 filed on Jul. 26, 2024, the content of which is relied upon and incorporated herein by reference in its entirety.

### FIELD

This description generally relates to hollow-core optical fibers and, more specifically, to single-mode, hollow-core optical fibers.

### BACKGROUND

Anti-resonant hollow-core optical fibers are traditionally comprised of a hollow, outer cladding inside of which a plurality of structural tubes are arranged. The structural tubes form an inner cladding comprised of multiple anti-resonant elements or membranes. In some traditional anti-resonant hollow-core optical fibers, the structural tubes are bonded to an inner surface of the outer cladding. Furthermore, each structural tube runs parallel to a length of the outer cladding. A central portion of the outer cladding, around which the structural tubes are arranged, remains hollow as an air-filled void. The resulting anti-resonant fiber guides light through the hollow-central portion of the core.

However, loss of light from the hollow core along the length of the optical fiber may be an impediment to implementing hollow-core optical fibers in practical applications. Accordingly, a need exists for hollow-core optical fibers having structures that confine light to the hollow core, thereby reducing light loss from the hollow core along the length of the optical fiber.

### SUMMARY

According to a first aspect of the present disclosure, a hollow-core optical fiber is disclosed that comprises an outer cladding comprising a tubular shape with a hollow interior, a plurality of inner cladding members positioned with the hollow interior, and a hollow core formed by the plurality of inner cladding members. The hollow-core optical fiber is configured to provide single-mode propagation of an optical signal within a wavelength range from 800 nm to 2000 nm.

According to a second aspect of the present disclosure, a hollow-core optical fiber is disclosed that comprises an outer cladding comprising a tubular shape with a hollow interior, a plurality of inner cladding members positioned with the hollow interior, and a hollow core formed by the plurality of inner cladding members, the hollow-core comprising a diameter of about 25.0 microns or less. A confinement loss of a single-mode of an optical signal propagating in the hollow-core optical fiber is less than or equal to 10⁻² dB/km within the wavelength range from 800 nm to 2000 nm.

Although many different embodiments are listed, the embodiments may exist individually or in any combination as possible. Hereinafter exemplary embodiments are shown and described.

### BRIEF DESCRIPTION OF THE DRAWINGS

FIG. 1 schematically depicts a cross-sectional view of a hollow-core optical fiber, according to the embodiments disclosed herein;

FIG. 2 schematically depicts a cross-sectional view of an inner cladding member of the hollow-core optical fiber of FIG. 1, according to the embodiments disclosed herein;

FIG. 3 schematically depicts a cross-sectional view of a ring member of the hollow-core optical fiber of FIG. 1, according to the embodiments disclosed herein;

FIG. 4 schematically depicts another cross-sectional view of the hollow-core optical fiber of FIG. 1, according to the embodiments disclosed herein;

FIG. 5 schematically depicts an enlarged, partial view of the hollow-core optical fiber of FIG. 1, according to the embodiments disclosed herein;

FIG. 6 schematically depicts another cross-sectional view of the hollow-core optical fiber of FIG. 1 with structural spacers, according to the embodiments disclosed herein;

FIG. 7 schematically depicts an enlarged, partial view of the hollow-core optical fiber of FIG. 1, according to the embodiments disclosed herein;

FIG. 8 schematically depicts a cross-sectional view of a hollow-core optical fiber, according to the embodiments disclosed herein;

FIGS. 9A-D schematically depict cross-sectional views of hollow-core optical fibers, according to the embodiments disclosed herein;

FIG. 10 graphically depicts the confinement loss of a first exemplary hollow-core optical fiber as a function of wavelength;

FIG. 11 graphically depicts the bending loss of the first exemplary hollow-core optical fiber as a function of bending radius;

FIG. 12 graphically depicts the confinement loss of a second exemplary hollow-core optical fiber as a function of wavelength; and

FIG. 13 graphically depicts the bending loss of the second exemplary hollow-core optical fiber as a function of bending radius.

### DETAILED DESCRIPTION

Reference will now be made in detail to various embodiments of hollow-core optical fibers. Whenever possible, the same reference numerals will be used throughout the drawings to refer to the same or like parts. In embodiments, hollow-core optical fibers may comprise an outer cladding, a hollow core extending through the outer cladding, and a plurality of inner cladding members positioned between the hollow core and the outer cladding. An inner cladding member element may comprise a plurality of glass ring members. In embodiments, the plurality of glass ring members are concentric rings. Embodiments, of the hollow-core optical fibers will be described in further detail herein.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Directional terms as used herein—for example up, down, right, left, front, back, top, bottom—are made only with reference to the figures as drawn and are not intended to imply absolute orientation.

Various components described herein may be referred to as “directly connected” or “indirectly connected”. Components are directly connected when they are joined to one another with no intervening structure. Components may be joined by fusing, welding, adhesives, or any other suitable attachment means. Components are “indirectly connected” when they are joined to one another with an intervening structure. Examples of intervening structures include welding aids (e.g. frits, solders, fluxes), adhesives, and bonding materials. In embodiments, components connected indirectly are connected only by a welding aid, adhesive, or bonding material. The term “connected” means “directly connected” or “indirectly connected”. Components “directly connected” to one another are said to be in direct contact with each other. Components “indirectly connected” to one another are said to be in indirect contact with each other. Components “connected” to one another are in direct or indirect contact with each other.

As used herein, the singular forms “a,” “an” and “the” include plural referents unless the context clearly dictates otherwise. Thus, for example, reference to “a” component includes aspects having two or more such components, unless the context clearly indicates otherwise.

Without intending to be bound by theory, an optical signal (i.e., light) may be passed through the hollow core of a hollow-core optical fiber. As used herein, “attenuation” refers to the reduction of power of the optical signal passing through the hollow-core optical fiber. Attenuation of the optical signal being guided through the hollow-core optical fiber may be reduced by various effects, including but not limited to, a photonic bandgap effect, an anti-resonant effect and an inhibited coupling mechanism. Each of these effects may reduce the leakage of light from the hollow core of the optical fiber to the cladding elements of the optical fiber, which in turn reduces the attenuation of the optical signal propagating in the hollow core. Said differently, each of these effects provides a mechanism to improve the confinement of light to the hollow core of the optical fiber, thereby reducing the attenuation of the optical signal propagating in the hollow core. Embodiments of hollow-core optical fibers described herein may comprise structures that utilize one or more of these effects to reduce the attenuation of an optical signal passing through the hollow-core optical fiber. Specifically, embodiments of hollow-core optical fibers described herein comprise structures that utilize all three of these effects to reduce the attenuation of an optical signal passing through the hollow-core optical fiber.

As used herein, a single-mode optical fiber is an optical fiber designed to carry only a single mode of light.

As used herein, “anti-resonance” or an “anti-resonant effect” refers to an effect that occurs when the thickness of a material (e.g. the material used to form cladding elements) is proportional to a wavelength of light passing through the hollow-core optical fiber such that the light passing through the hollow-core optical fiber is confined to the hollow core. Without intending to be bound by theory, an anti-resonant effect occurs when the thickness of a material satisfies the quarter-wave condition (phase accumulated on a single pass is one quarter of 2π, and any odd multiple of a quarter wave). When this condition is applied to the thickness of the material, light is confined to the hollow core with minimum leakage to the cladding. In other words, this condition helps inhibit coupling between core modes and cladding modes, resulting in low loss of transmission and increased confinement of the optical signal in the hollow core. The anti-resonant effect may, in embodiments, be satisfied by a material having a thickness given by Equation 1:

$${t}_{A R} = \frac{( 2 m - 1 ) λ}{4 \sqrt{{n}^{2} - 1}} \qquad ( 1 )$$

In Equation 1, t_{AR} is the thickness of the material that satisfies the anti-resonance condition, λ is the wavelength of the optical signal (core mode), m is an integer that is greater than or equal to 1, and n is the refractive index of the material. It should be noted that Equation 1 represents an ideal thickness of a material that would satisfy the anti-resonant effect, and that material thicknesses that are not exactly equal to t_{AR} may also provide increased confinement of light to the hollow core. For example, without limitation, it is contemplated that a material having a thickness within 10% of t_{AR} (from 90% t_{AR} to 110% t_{AR}) may be operable to confine or substantially confine light to the hollow core.

As used herein, an “inhibited coupling mechanism” refers to an effect that occurs when cladding elements having negative curvature inhibit coupling between core modes and cladding modes to reduce light leakage from the hollow core. As used herein, “negative curvature” refers to cladding elements having a surface with a convex shape facing the central longitudinal axis of the hollow-core optical fiber. Without intending to be bound by theory, using cladding elements having a surface with a convex shape facing the central longitudinal axis of the hollow-core optical fiber may reduce the amount of light that contacts the cladding elements and may also reduce the light leaking through the cladding elements and the gaps between these cladding elements. In turn, this may reduce attenuation of the optical signal due to the leaking through the cladding elements and the gaps between them and may also reduce light scattering that may occur when light contacts the surface of the cladding elements.

As is known in the art, there are at least two types of hollow core fibers. The first type is a photonic bandgap hollow core fiber in which the cladding is comprised of a periodic concentric structure to realize a photonic bandgap effect, which is the high reflection of light at an interface between the hollow core and cladding material. Photonic bandgap hollow core fibers can be further divided into one dimensional Bragg structure fibers and two dimensional photonic crystal structure fibers. The second type of hollow core fibers is an anti-resonant hollow core fiber in which the fiber cladding comprises one or more layers of thin glass structural tubes satisfying anti-resonant conditions to prevent light from leaking out of the air core.

Embodiments of the present disclosure utilize optical guiding aspects based on the photonic bandgap and the anti-resonant fiber principles to achieve low confinement loss of the optical signal while propagating as single-mode. Furthermore, embodiments of the present disclosure also utilize the inhibited coupling mechanism to achieve the low confinement loss with single-mode propagation. In particular, and as discussed further below, embodiments of the present disclosure comprise a plurality of inner cladding members that are each comprised of a plurality of ring members. The arrangement of the ring members within the hollow-core optical fibers disclosed herein confine and guide light within the hollow core of the fibers based on the principles of the photonic bandgap effect. Furthermore, the spacing between adjacent ring members confine and guide light based on the principles of the anti-resonant effect. And the structure of the ring members with negative curvatures confine and guide light based on the principles of the inhibited coupling mechanism. These principles together greatly reduce attenuation within the hollow-core optical fibers disclosed herein and provide for single-mode hollow-core fibers over a wide wavelength range.

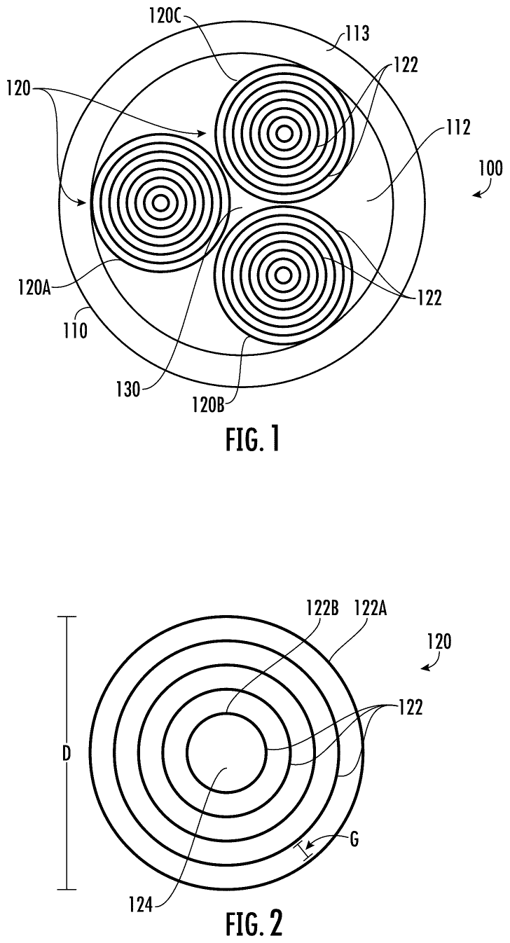

Referring now to FIG. 1, an exemplary cross-sectional view of a hollow-core optical fiber 100 is shown. Fiber 100 comprises an outer cladding 110 and a plurality of inner cladding members 120. As discussed further below, each of the inner cladding members 120 comprises a plurality of ring members 122. A hollow core 130 is formed within a central region of hollow-core optical fiber 100.

Outer cladding 110 is a hollow, cylindrical member formed of glass. In particular, outer cladding 110 comprises an edge member 113 and a hollow interior 112. Edge member 113 border hollow interior 112 such that outer cladding 110 forms a ring-like, donut shape in cross-section (as shown in FIG. 1). Edge member 113 may be a solid member or a tube-like member, such that an interior of edge member 113 is hollow. In some embodiments, outer cladding 110 (edge member 113) is formed of doped or undoped silica glass. In embodiments, outer cladding 110 may consist essentially of or consist of silica-based glass.

Inner cladding members 120 are each disposed within hollow interior 112 of outer cladding 110. Although FIG. 1 shows three different inner cladding members 120, it is also contemplated that hollow-core optical fiber 100 may comprise more inner cladding members 120. In the embodiment of FIG. 1, hollow-core optical fiber 100 comprises inner cladding members 120A, 120B, and 120B disposed symmetrically within hollow interior 112. As also discussed further below, each inner cladding member 120 comprises the plurality of ring members 122. In the embodiment of FIG. 1, ring members 122 are concentric rings of glass. Ring members 122 may be formed of doped or undoped silica glass. In embodiments, ring members 122 may consist essentially of or consist of silica-based glass. In embodiments, outer cladding 110 and ring members 122 are formed of the same material. In other embodiments, outer cladding 110 and ring members 122 are formed of different materials.

Each inner cladding member 120 comprises the plurality of ring members 122. In the embodiment shown in FIG. 1, each of the inner cladding members 120A, 120B, 120C comprises 8 ring members 122. However, each inner cladding member 120 in the embodiments disclosed herein may comprise more or less ring members 122, such as, for example, 2 or more, or 3 or more, or 4 or more, or 5 or more, or 6 or more, or 7 or more, or 8 or more, or 9 or more, or 10 or more, or 11 or more, or 12 or more, or 13 or more, or 14 or more, or 15 or more. Additionally or alternatively, the number of ring members 122 in each inner cladding member 120 may be 15 or less, or 14 or less, or 13 or less, or 12 or less, or 11 or less, or 10 or less, or 9 or less, or 8 or less, or 7 or less, or 6 or less, or 5 or less, or 4 or less, or 3 or less. In embodiments, the number of ring members 122 in each inner cladding member 120 is from 2 to 15, or from 3 to 14, or from 4 to 13, or from 5 to 12, or from 6 to 11, or from 7 to 10, or from 8 to 9, or any range encompassing these endpoints. The greater the number of ring members 122 advantageously helps to confine propagating light to hollow core 130 of hollow-core optical fiber 100. But the number of ring members 122 is limited by the spacing constraints within outer cladding 110. The spacing constraints are due, in part, to the need for sufficient distance between adjacent ring members 122, in order to utilize the photonic bandgap effect.

It is also contemplated that one or more inner cladding members 120 may have the same or different number of ring member 122 as one or more other inner cladding members 120. For example, inner cladding member 120A may have more ring members 122 than inner cladding member 120B. Furthermore, one or more inner cladding members 120 may have the same or different outer diameter as one or more other inner cladding members 120. For example, inner cladding member 120B may have a larger outer diameter than inner cladding member 120C. It is noted that the number of ring members 122 and the spacing between ring members 122 directly corresponds to the outer diameter size of the inner cladding member 120.

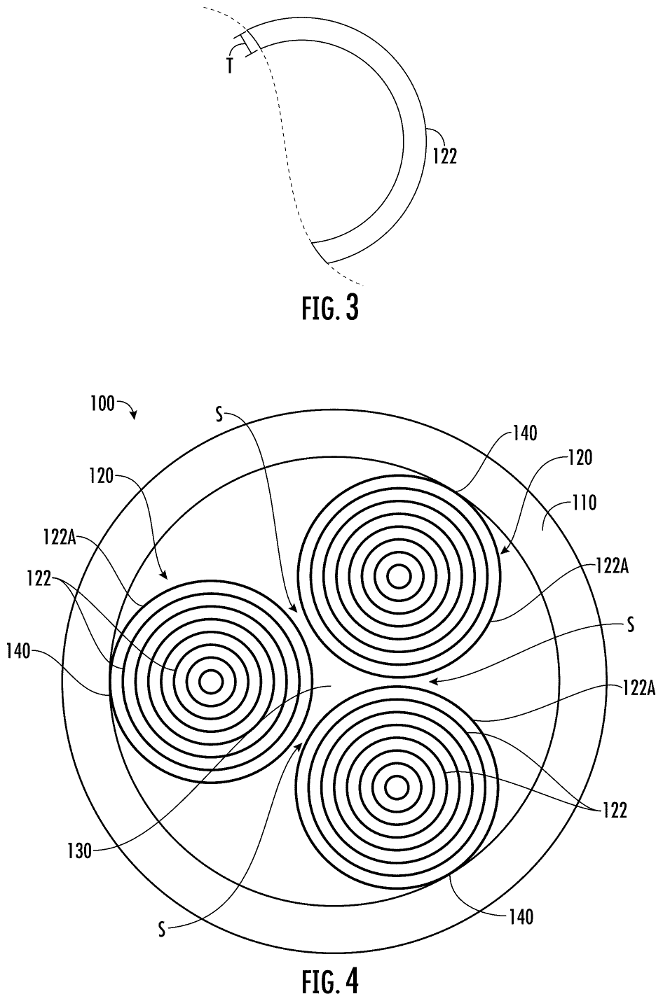

FIG. 2 shows an exemplary inner cladding member 120 with ring members 122 that become progressively smaller in diameter towards a radial center of inner cladding member 120. Therefore, the radially outward-most ring member 122A has the largest outer diameter in a particular inner cladding member 120. And, the radially inward-most ring member 122B has the smallest outer diameter in a particular inner cladding member 120. In the embodiment of FIG. 2, inner cladding member 120 has 5 ring members 122. In embodiments, ring members 122 are concentric rings. In some particular embodiments, ring members 122 are concentric about a radial center of inner cladding member 120. In other embodiments, one or more ring members 122 may be radially off center from one or more other ring members 122 in a particular inner cladding member 120.

The outer diameter D of inner cladding member 120 is the outer diameter of the radially outward-most ring member 122A, as shown in FIG. 2. In embodiments, the outer diameter D is about 15 microns or greater, or about 18 microns or greater, or about 20 microns or greater, or about 22 microns or greater, or about 25 microns or greater, or about 28 microns or greater, or about 30 microns or greater, or about 32 microns or greater, or about 35 microns or greater, or about 38 microns or greater, or about 40 microns or greater, or about 42 microns or greater, or about 45 microns or greater, or about 50 microns or greater. Additionally or alternatively, the outer diameter D is about 200 microns or smaller, or about 175 microns or smaller, or about 150 microns or smaller, or about 125 microns or smaller, or about 100 microns or smaller, or about 80 microns or smaller, or about 75 microns or smaller, or about 60 microns or smaller, or about 50 microns or smaller, or about 48 microns or smaller, or about 45 microns or smaller, or about 42 microns or smaller, or about 40 microns or smaller, or about 38 microns or smaller, or about 35 microns or smaller, or about 32 microns or smaller, or about 30 microns or smaller. In embodiments, the outer diameter D is in a range from about 15 microns to about 200 microns, or about 18 microns to about 175 microns, or about 20 microns to about 150 microns, or about 22 microns to about 80 microns, or about 25 microns to about 75 microns, or about 28 microns to about 60 microns, or about 30 microns to about 50 microns, or about 32 microns to about 48 microns, or about 35 microns to about 45 microns, or about 38 microns to about 42 microns, or about 38 microns to about 40 microns, or about 30 microns to about 40 microns, or any range encompassing these endpoints.

The radially inward-most ring member 122B forms a central region 124, which is a hollow region that overlaps with the hollow interior 112 of outer cladding 110. As discussed further below, ring members 122 may be complete and full circles in cross-section or may be partial circles in cross-section. In embodiments, radially inward-most ring member 122B is a complete and full circle such that central region 124 is radially surrounded by inward-most ring member 122B.

As also shown in FIG. 2, adjacent ring members 122 may be spaced apart from each other such that hollow interior 112 of outer cladding 110 is between the adjacent ring members 122. In particular, adjacent ring members 122 may be spaced apart by a gap G, which may be about 1 micron or greater, or about 2 microns or greater, or about 3 microns or greater, or about 4 microns or greater, or about 5 microns or greater, or about 6 microns or about 7 microns or greater, or about 8 microns or greater, or about 9 microns or greater or about 10 microns or greater. Additionally or alternatively, the gap G may be about 10 microns or less, or about 9 microns or less, or about 8 microns or less, or about 7 microns or less, or about 6 microns or less, or about 5 microns or less, or about 4 microns or less, or about 3 microns or less, or about 2 microns or less, or about 1 micron or less. In embodiments, the gap G is in a range from about 1 micron to about 10 microns, or about 2 microns to about 9 microns, or about 3 microns to about 8 microns, or about 4 microns to about 7 microns, or about 5 microns to about 6 microns, or any range encompassing these endpoints. The gap G must be sufficiently long in length in order to provide the above-described photonic bandgap effect.

A first gap G₁ between two adjacent ring members 122 in a particular inner cladding member 120 may the same or different from a second gap G₂ between two different adjacent ring members 122 in the same inner cladding member 120. Thus, ring members 122 may be spaced differently from each other in the same inner cladding member 120. In embodiments, all of the ring members 122 in a particular inner cladding member 120 are spaced the same distance (or substantially the same distance) from each other (such that the gap G is the same between all of the adjacent ring members 122 in the particular inner cladding member 120). In yet some other embodiments, all of the ring members 122 in all of the inner cladding members 120 in hollow-core optical fiber 100 are spaced the same distance from each other (such that the gap G is the same between all of the adjacent ring members 22 in the hollow-core optical fiber 100).

It is also contemplated that the gaps G between adjacent ring members 122 may not be consistent between the entirety of the adjacent ring members 122. More specifically, although FIG. 2 shows the gaps G as being consistent between any two particular adjacent ring members 122, the gaps G may vary in size between the same two adjacent ring members 122. For example, and with reference to FIG. 2, a single gap G between the same two adjacent ring members 122 may be greater on a left side of the cross-sectional view of FIG. 2 than on a right side of the cross-sectional view.

Ring members 122 may each be a solid member. In yet some other embodiments, one or more ring member 122 are a tube-like member, such that an interior of the ring members 122 is hollow.

FIG. 3 shows an enlarged view of a portion of a single ring member 122. As shown in FIG. 3, each ring member 122 has a cross-sectional thickness T of about 300 nm or greater, or about 325 nm or greater, or about 350 nm or greater, or about 375 nm or greater, or about 400 nm or greater, or about 425 nm or greater, or about 450 nm or greater, or about 475 nm or greater, or about 500 nm or greater, or about 525 nm or greater, or about 550 nm or greater, or about 575 nm or greater, or about 600 nm or greater, or about 700 nm or greater, or about 800 nm or greater, or about 900 nm or greater, or about 1000 nm or greater, or about 1100 nm or greater, or about 1200 nm or greater, or about 1300 nm or greater. Additionally or alternatively, the thickness T is about 1300 nm or less, or about 1200 nm or less, or about 1100 nm or less, or about 1000 nm or less, or about 900 nm or less, or about 800 nm or less, or about 700 nm or less, or about 600 nm or less, or about 575 nm or less, or about 550 nm or less, or about 525 nm or less, or about 500 nm or less, or about 475 nm or less, or about 450 nm or less, or about 425 nm or less, or about 400 nm or less, or about 375 nm or less, or about 350 nm or less, or about 325 nm or less, or about 300 nm or less. As discussed above with regard to Equation 1, the thickness T of ring members 22 is related to the anti-resonant effect. In embodiments, when m is equal to 1 from Equation 1 above, the thickness T is in a range from about 300 nm to about 600 nm, or about 325 nm to about 575 nm, or about 350 nm to about 550 nm, or about 375 nm to about 525 nm, or about 400 nm to about 500 nm, or about 425 nm to about 475 nm, or about 450 nm to about 475 nm, or any range encompassing these endpoints for wavelengths of 1550 nm. In embodiments, when m is equal to 2 from Equation 1 above, the thickness T is in a range from about 1000 nm to about 1300 nm, or about 1100 nm to about 1200, or any range encompassing these endpoints, for wavelengths of 1550 nm.

A length of each ring member 122 runs parallel to a length of hollow-core optical fiber 100. Furthermore, the length of each ring member 122 may be equal to (or substantially equal to) the length of hollow-core optical fiber 100. In other embodiments, one or more ring members 122 may be shorter in length than hollow-core optical fiber 100.

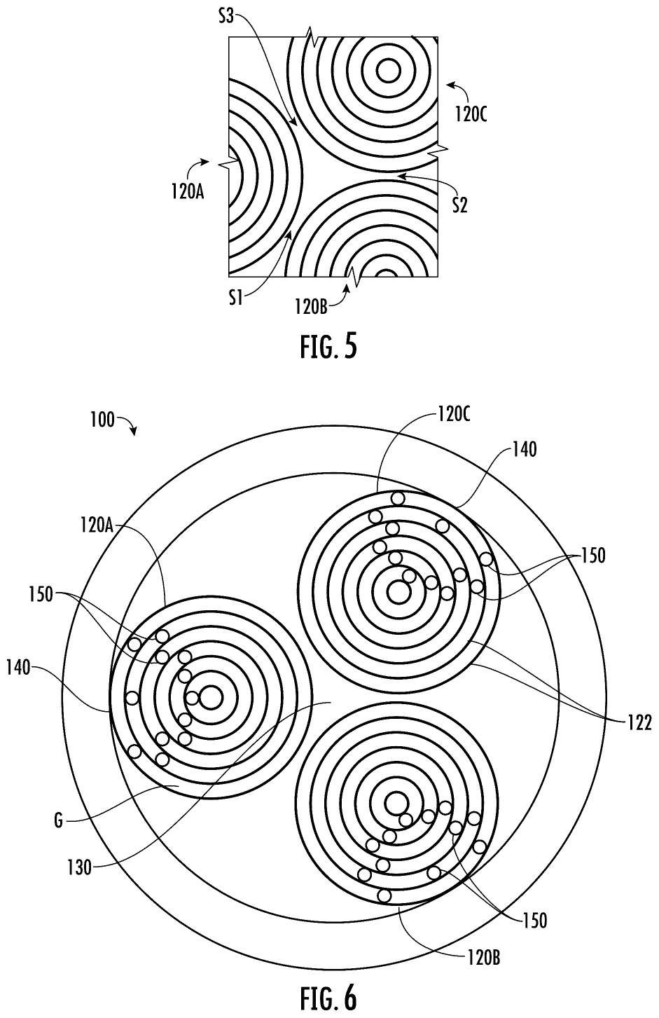

With reference now to FIG. 4, an enlarged cross-sectional view of hollow-core optical fiber 100 is shown. As shown in FIG. 4, each inner cladding member 120 may be in direct contact with outer cladding 110. More specifically, the radially outward-most ring member 122A of each inner cladding member 120 contacts outer cladding 110. In embodiments, the radially outward-most ring member 122A of each inner cladding member 120 contacts outer cladding 110 at a contact location 140, which may be a discrete point on outer cladding 110 and/or ring member 122A or a segment along outer cladding 110 and/or ring member 122A. Furthermore, each contact location 140 may be a direct connection or an indirect connection between ring member 122A and inner cladding 110. For example, ring member 122A and inner cladding 110 may be directly connected via welding and/or sintering. Each inner cladding member 120 contacts outer cladding 110 at contact location 140 in order to secure the inner cladding members 120 within hollow-core optical fiber 100 and to reduce and/or prevent movement of these members within hollow interior 112.

Although inner cladding members 120 are in direct contact with outer cladding 110 (at contact location), in embodiments, each inner cladding member 120 is spaced apart from the other inner cladding members 120 within a hollow-core optical fiber 100. Therefore, with reference to FIG. 4, inner cladding members 120 are spaced apart from each other by a distance S. In embodiments, the distance S is about 5.0 microns or less, or about 4.5 microns or less, or about 4.0, or about 3.5 microns or less, or about 3.0 microns or less, or about 2.5 microns or less, or about 2.0 microns or less, or about 1.5 microns or less, or about 1.0 microns or less, or about 0.75 microns or less, or about 0.50 microns, or less, or about 0.25 microns or less, or any range encompassing these endpoints. For example, in embodiments, the distance S is from about 0.25 microns to about 5.0 microns, or about 0.50 microns to about 4.5 microns, or about 0.75 microns to about 4.0 microns, or about 1.0 microns to about 3.5 microns, or about 1.5 microns to about 3.0 microns, or about 2.0 microns to about 2.5 microns.

As further shown in FIG. 5, the distance S between the different inner cladding members 120 may be the same or different. For example, in the exemplary embodiment of FIG. 5, the distance between inner cladding member 120A and 120B is S1, the distance between inner cladding members 120B and 120C is S2, and the distance between inner cladding members 120C and 120A is S3. Each of S1, S2, and S3 may be within the above-disclosed ranges for distance S. However, in embodiments, for example, at least one of S1, S2, and S3 are different from each other. For example, in one exemplary embodiment, S1>S2>S3. In another exemplary embodiment, S1>S2=S3. In yet another exemplary embodiment, S1=S2=S3.

The spacing S between the different inner cladding members 120 advantageously reduces confinement loss of an optical signal propagating in the hollow core 130 of hollow-core optical fiber 100.

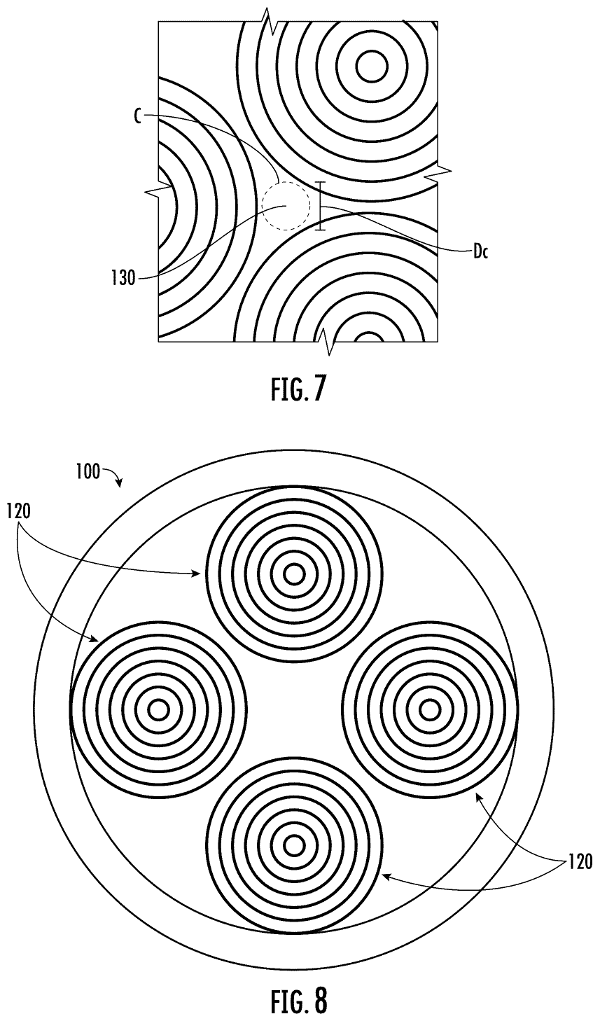

As shown in FIG. 6, in embodiments, hollow-core optical fiber 100 may comprise structural spacers 150 in the gaps G between the different ring members 122 of inner cladding members 120. Structural spacers 150 advantageously help to secure ring members 122 within hollow-core optical fiber 100 and to reduce and/or prevent movement of these members within hollow interior 112. In embodiments, inner cladding members 120 may each comprise one or more structural spacers 150. Each inner cladding members 120 may comprise the same or different number of structural spacers 150 as the other inner cladding members 120 in hollow-core optical fiber 100. Therefore, for example, inner cladding member 120A may comprise more structural spacers 150 than each of inner cladding members 120B and 120C. In some embodiments, inner cladding members 120A, 120B, and 120C all comprise the same number of structural spacers 150.

As discussed above, structural spacers 150 are disposed within the gaps G between adjacent ring members 122. Each gap G may comprise one or more structural spacers 150. Therefore, for example, a single gap G between first and second ring members 122 may comprise more than one separate structural spacer 150 (such as, for example, 2 or 3 structural spacers 150). Structural spacers 150 may be glass members formed of, for example, doped or undoped silica glass. In embodiments, structural spacers 150 may consist essentially of or consist of silica-based glass. In embodiments, structural spacers 150 comprise the same material as ring members 122.

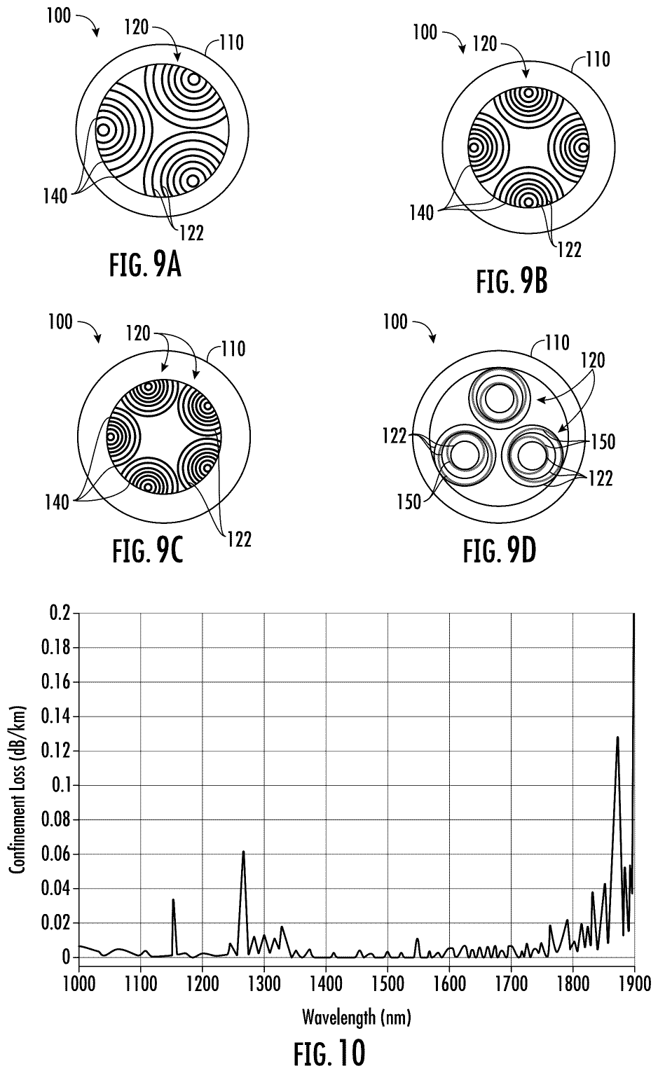

Structural spacers 150 may comprise a variety of shapes and configurations. As shown in FIG. 6, structural spacers 150 may be circular in cross-section. In embodiments, structural spacers 150 may comprise other shapes in cross-section, such as, for example, square, elliptical, or triangular. In yet other embodiments, structural spacers 150 are ring-like members in cross-section within the gaps G (as shown in FIG. 9d and as discussed further below). The ring-like structural spacers 150 may be concentric about a radial center of inner cladding member 120. In other embodiments, one or more of the ring-like structural spacers 150 may be radially off center from one or more other ring-like structural spacers 150 in a particular inner cladding member 120. Furthermore, the ring-like structural spacers 150 may be concentric with ring members 122 about a radial center of inner cladding member 120. In other embodiments, one or more of the ring-like structural spacers 150 may be radially off center from one or more ring members 122 in a particular inner cladding member 120. In embodiments, structural spacers 150 are a solid member or a tube-like member in cross-section, such that an interior of the structural spacer 150 is hollow.

As shown in FIG. 6, each structural spacer 150 contacts the ring members 122 that it is positioned between. Therefore, each structural spacer 150 contacts two ring members 122. The connection between each structural spacer 150 and ring members 122 may be direct or indirect. For example, each structural spacer 150 may be directly connected to ring members 122 via, for example, welding and/or sintering. In yet some other embodiments, each structural spacer 150 overlaps with a ring member 122 such that the material of the structural spacer 150 lies over and becomes incorporated with the material of ring member 122 at the connection between these two components. Furthermore, a length of each structural spacer 150 runs parallel to a length of hollow-core optical fiber 100. The length of each structural spacer 150 may be equal to (or substantially equal to) the length of hollow-core optical fiber 100. In other embodiments, one or more structural spacers 150 may be shorter in length than hollow-core optical fiber 100. Additionally, the length of each structural spacer 150 may be equal to (or substantially equal) to the length of ring members 122 that it directly contacts.

Structural spacers 150 may be positioned in a variety of patterns and configurations within the gaps G of inner cladding members 120. For example, structural spacers 150 may be positioned symmetrically or asymmetrically within an inner cladding member 120. In the embodiment of FIG. 6, structural spacers 150 are positioned relatively closer to the contact location 140 rather than to hollow core 130. Furthermore, in some embodiments, central region 124 of inner cladding members 120 may not comprise any structural spacers 150.

In embodiments, hollow interior 112 of outer cladding 110 may comprise one or more gasses. Thus, the gap G between ring members 12, central region 124, and hollow core 130 may each comprise one or more gasses. In embodiments, hollow interior 112 (and, thus, ring members 122, central region 124, and hollow core 130) may comprise one or more inert gasses. In embodiments, hollow interior 112 (and, thus, ring members 122, central region 124, and hollow core 130) may comprise, consist essentially of, or consist of air.

With reference now to FIG. 7, hollow core 130 is formed by inner cladding members 120 such that hollow core 130 is radially central of inner cladding members 120. Hollow core 130 is configured to confine and propagate light within hollow-core optical fiber 100. As shown in FIG. 7, hollow core 130 generally has the shape C with diameter Dc. In embodiments, the diameter Dc is about 25.0 microns or less, or about 22.5 microns or less, or about 20.0 microns or less, or about 18.0 microns or less, or about 16.0 microns or less, or about 14.0 microns or less, or about 12.0 microns or less, or about 10.0 microns or less, or about 8.0 microns or less, or about 6.0 microns or less, or about 4.0 microns or less, or about 2.0 microns or less, or about 1.0 micron, or any range encompassing these endpoints. For example, the diameter Dc may be in range from about 1.0 micron to about 25.0 microns, or about 2.0 microns to about 22.5 microns, or about 4.0 microns to about 20.0 microns, or about 6.0 microns to about 18.0 microns, or about 8.0 microns to about 16.0 microns, or about 10.0 microns to about 14.0 microns, or about 12.0 microns to about 14.0 microns.

In embodiments, hollow core 130 is configured to transmit light having a wavelength from 800 nm to 2000 nm as single-mode. Thus, hollow core 130 is configured to transmit light as single-mode over this entire wavelength range. The propagation of light through hollow core 130 as single-mode, within a particular wavelength range, may be dependent on the diameter De of hollow core 130. In particular, in embodiments, single-mode operation of hollow core 130 occurs when the diameter De of hollow core 130 is within the above-disclosed ranges (e.g., about 25 microns or less) and the wavelength of the optical signal transmitted by hollow-core optical fiber 100 is any wavelength within the range from 800 nm to 2000 nm. Furthermore, hollow core 130 is configured to transmit the light as single-mode over a distance of about 2 m or more, or about 20 m or more, or about 50 m or more, or about 100 m or more.

As discussed above, hollow-core optical fiber 100 may comprise a plurality of inner cladding members 120. FIG. 8 shows an embodiment in which hollow-core optical fiber 100 comprises four inner cladding members 120. As also discussed above, ring members 122 may be complete and full circles in cross-section or may be partial circles in cross-section. It is also contemplated in embodiments that one or more ring members 122 in an inner cladding member 120 is a full circle in cross-section while one or more other ring members 122 in the same inner cladding member 120 is a partial circle in cross-section. FIGS. 9A-C show exemplary embodiments of hollow-core optical fiber 100 in which at least some ring members 122 are partial circles in cross-section. It is noted that these embodiments, which include the ring members 122 with partial circles, have a plurality of contact locations 140 with outer cladding 110. Due to the plurality of contact locations 140, these embodiments may not require the need for structural spacers 150 between ring members 122.

FIG. 9D shows an embodiment in which structural spacers 150 comprise the ring-like members discussed above. In this particular embodiment, the ring-like structural members 150 are radially offset from each other and radially offset from ring members 122.

In embodiments described herein, the plurality of inner cladding members 120 are configured to confine the single, fundamental mode of an optical signal (i.e., light) propagating in hollow core 130 of hollow-core optical fiber 100 by one or more of the photonic bandgap effect, the anti-resonant effect, and the inhibited coupling mechanism. In embodiments, and as discussed above, the single-mode of the optical signal guided by the hollow core 110 has a wavelength λ from 800 nm to 2000 nm. In embodiments, the plurality of inner cladding members 120 are configured to provide a photonic bandgap effect, an anti-resonant effect, and/or an inhibited coupling mechanism at a wavelength from 800 nm to 2000 nm, the photonic bandgap effect, the anti-resonant effect, and/or the inhibited coupling mechanism operable to confine an optical signal propagating in the hollow-core optical fiber 100 at a wavelength from 800 nm to 2000 nm in hollow core 130.

Without intending to be bound by theory, confinement loss may be the dominant attenuation factor in hollow-core optical fibers. Confinement loss may occur as light leaks from a hollow core to the cladding elements in a hollow-core optical fiber. Confinement loss may be calculated using Equation 2 and Equation 3:

$${n}_{eff} = {n}_{r} + i \cdot {n}_{im} \qquad ( 2 )$$

$$CL [ \frac{dB}{km} ] = \frac{20}{ln ( 10 )} \cdot \frac{2 π}{λ} \cdot Im ( {n}_{eff} ) \cdot {10}^{3} \qquad ( 3 )$$

In Equations 2 and 3, n_{eff} is the effective index of the mode with wavelength λ propagating in the hollow-core fiber with the real part of nᵣ and the imaginary part of nᵢₘ. The wavelength is in the units of meters. The real part of the effective index is related to the propagation speed of the mode and the imaginary part is related to the confinement loss of the mode. For an anti-resonant hollow-core fiber with a given structure and composition of the core and the cladding, the effective index may be determined using a fiber modeling tool, such COMSOL Multiphysics®. The confinement loss CL is calculated using Equation 3.

In embodiments, the plurality of inner cladding members 120 are configured such that a minimum confinement loss of the single, fundamental mode of the optical signal propagating in the hollow-core optical fiber 100 is less than 10⁻² dB/km at the wavelength λ of the single, fundamental mode guided by hollow core 130. For example, without limitation, the plurality of inner cladding members 120 are configured such that a confinement loss of the single, fundamental mode of the optical signal propagating in the hollow core 130 of hollow-core optical fiber 100 at a wavelength λ may be less than 10⁻² dB/km, less than 10⁻³ dB/km, or even less than 10⁻⁴ dB/km at any wavelength within the range from 800 nm to 2000 nm.

As described herein, “bending loss” refers to a difference between the attenuation of a hollow-core optical fiber in a bent configuration and a straight configuration. Without intending to be bound by theory, bending loss is the additional propagation loss caused by coupling light from core modes to cladding modes when the fiber is bent. A bend in a fiber may be described in terms of a bend radius or radius of curvature, which refers to the radius of a hypothetical circle (or arc) having the same curvature as the bend. Bending loss may be determined by using a mandrel wrap test. In this test method, light is launched into a test fiber with a portion wrapped on a mandrel of known bend radius R with one or more turns N and the output power P is measured first. Without disturbing the launch condition, the wrapped fiber portion is released to a straight condition and the output power P₀ is then measured. The bending loss of the fiber an is calculated using Equation 4:

$${α}_{B} ( \frac{dB}{turn} ) = \frac{10 log ( {P}_{0} / P )}{N} \qquad ( 4 )$$

In embodiments, hollow-core optical fiber 100 has a minimum bending loss of a fundamental mode of an optical signal propagating in hollow core 130 of less than or equal to 1 dB/km at the wavelength λ for a bend radius of 3 cm to 20 cm. For example, without limitation, hollow-core optical fiber 100 may have a minimum bending loss of less than or equal to 0.1 dB/km, 0.08 dB/km, 0.06 dB/km, 0.04 dB/km, 0.02 dB/km or 0.01 dB/km at any wavelength λ within the range from 800 nm to 2000 nm for a bend radius from 3 cm to 20 cm, 5 cm to 20 cm, 10 cm to 20 cm, 15 cm to 20 cm, 3 cm to 15 cm, 3 cm to 10 cm, or 3 cm to 5 cm.

Embodiments of the hollow-core optical fibers described herein may be made by the following method. The inner cladding members may be formed by producing silica-based glass tubes. The inner cladding members may be sleeved into an outer cladding in a desired arrangement. The inner cladding elements may be joined to the outer cladding and to each other via structural spacers, as desired, to form a preform assembly. The inner cladding members and outer cladding may be joined by any suitable means, such as, but not limited to setting against, pressing, heating, fusing, welding, and adhesives. Techniques for welding include laser welding, flame welding, and plasma welding. The preform assembly may be redrawn into a fiber preform using conventional fiber redraw techniques. The fiber preform may then be drawn into optical fiber using conventional fiber drawing techniques.

In embodiments, a light source may be used to launch light within hollow core 130 of hollow-core optical fiber. As discussed above, the light may have a wavelength within the range from 800 nm to 2000 nm. The light source may be, for example, a super-luminescent diode, a laser source configured to emit light at the above-disclosed wavelengths, a tunable laser, or a laser such as DFB laser with fixed wavelength, or the like. For example, the light source may be a narrow linewidth light source. The light source may be configured to provide polarized light that is modulated. In other embodiments, the light source may be a vertical cavity surface emitting laser (VCSEL).

A first exemplary optical fiber with the configuration shown in FIG. 1 was modeled to determine the confinement loss of the fiber. The first exemplary optical fiber had 3 inner cladding members 120 surrounded by an outer cladding 110. Each inner cladding member 120 included 7 ring members 122, each with a thickness T of 400 nm. The gap G between ring members 122 was 4.6 microns. The hollow core 130 of the first exemplary optical fiber had a diameter Dc of 13 microns.

The confinement loss of the first exemplary optical fiber was modeled using COMSOL Multiphysics® modeling software over wavelengths ranging from 1000 nm to 1900 nm. The results are shown in FIG. 10. According to the model, the first exemplary optical fiber provided good confinement of a fundamental mode of an optical signal to hollow core 130 of the fiber. In particular, the confinement loss of the first exemplary optical fiber was less than 0.1 dB/km over the broad wavelength range from 1000 nm to 1800 nm.

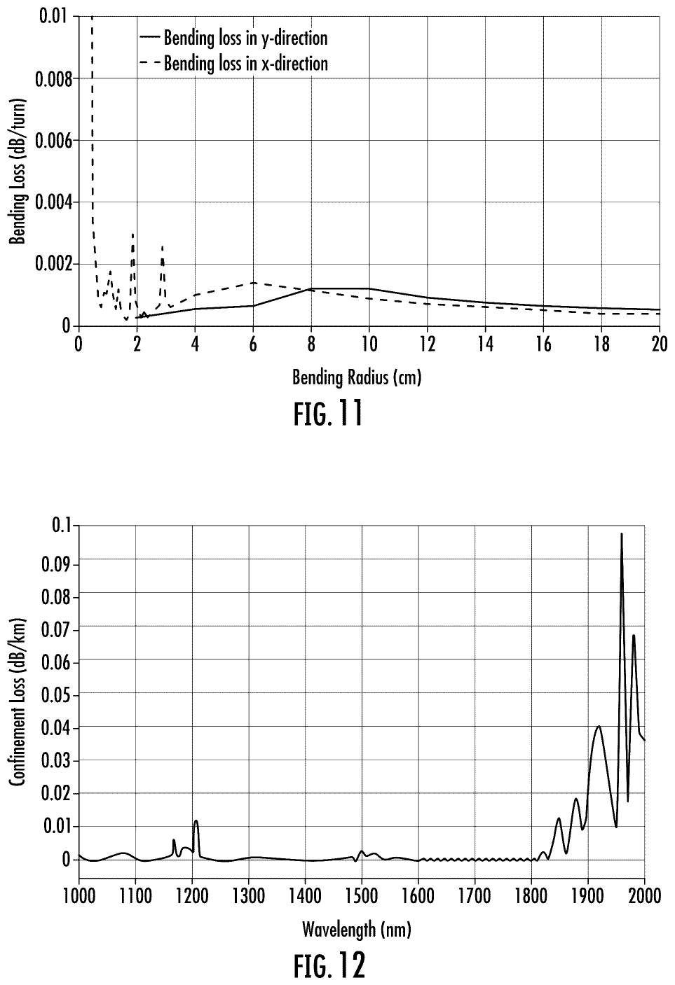

The bending loss of the first exemplary fiber was modeled using the COMSOL Multiphysics® modeling software at 1500 nm for bending in an x-direction and a y-direction at a variety of bending radii. The results are shown in FIG. 11. According to the model, bending losses are less than 0.004 dB/turn for x-direction bending and less than 0.002 dB/turn for y-axis direction bending over the bending radii range from 2 cm to 20 cm.

A second exemplary optical fiber with the configuration shown in FIG. 8 was modeled to determine the confinement loss of the fiber. The second exemplary optical fiber had 4 inner cladding members 120 surrounded by an outer cladding 110. Each inner cladding member 120 included 6 ring members 122, each with a thickness T of 400 nm. The gap G between ring members 122 was 4.6 microns. The hollow core 130 of the first exemplary optical fiber had a diameter Dc of 26 microns.

The confinement loss of the second exemplary optical fiber was modeled using COMSOL Multiphysics® modeling software over wavelengths ranging from 1000 nm to 2000 nm. The results are shown in FIG. 12. According to the model, the second exemplary optical fiber provided good confinement of a fundamental mode of an optical signal to hollow core 130 of the fiber. In particular, the confinement loss of the first exemplary optical fiber was less than 0.1 dB/km over the broad wavelength range from 1000 nm to 2000 nm.

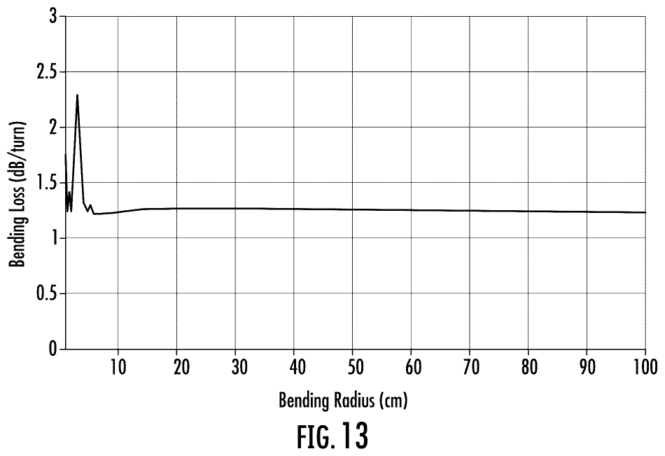

The bending loss of the second exemplary fiber was modeled using the COMSOL Multiphysics® modeling software at 1500 nm for bending in an x-direction at a variety of bending radii. The results are shown in FIG. 13. According to the model, bending losses are less than 0.0025 dB/turn over the bending radii shown.

The present disclosure is directed to various embodiments of hollow-core optical fibers. In embodiments, the hollow-core optical fiber comprises a substrate, the substrate comprising a tubular shape and an inner surface surrounding a central longitudinal axis of the hollow-core optical fiber; a hollow core extending through the substrate along the central longitudinal axis; and a plurality of cladding elements positioned between the central longitudinal axis of the hollow-core optical fiber and the substrate. Each of the plurality of cladding elements may include a wound glass sheet configured as a spiral, and each of the plurality of cladding elements may contact an interior surface of the substrate. The hollow-core optical fibers may be operable to transmit optical signals, and the cladding elements may reduce attenuation of the optical signals through one or more of a photonic bandgap effect, an anti-resonant effect and an inhibited coupling mechanism.

According to a first aspect, a hollow-core optical fiber comprising an outer cladding comprising a tubular shape with a hollow interior, a plurality of inner cladding members positioned with the hollow interior, and a hollow core formed by the plurality of inner cladding members, wherein the hollow-core optical fiber is configured to provide single-mode propagation of an optical signal within a wavelength range from 800 nm to 2000 nm.

According to a second aspect, the hollow-core optical fiber of the first aspect, wherein the hollow core comprises a diameter of about 25.0 microns or less.

According to a third aspect, the hollow-core optical fiber of the second aspect, wherein the diameter of the hollow core is about 20.0 microns or less.

According to a fourth aspect, the hollow-core optical fiber of any one of the first through third aspects, wherein a confinement loss of the single-mode of the optical signal propagating in the hollow-core optical fiber is less than or equal to 10⁻² dB/km within the wavelength range from 800 nm to 2000 nm.

According to a fifth aspect, the hollow-core optical fiber of any one of the first through fourth aspects, wherein a bending loss of the single-mode of the optical signal propagating in the hollow-core optical fiber is less than or equal to 0.1 dB/km at the wavelength range from 800 nm to 2000 nm for a bend radius of 3 cm to 20 cm.

According to a sixth aspect, the hollow-core optical fiber of any one of the first through fifth aspects, wherein the plurality of inner cladding members each comprises a plurality of ring members, the plurality of ring members each comprising a glass member separated from adjacent ring members by a gap.

According to a seventh aspect, the hollow-core optical fiber of the sixth aspect, wherein the plurality of ring members comprises a plurality of concentric rings.

According to an eight aspect, the hollow-core optical fiber of the sixth or seventh aspects, wherein each inner cladding member comprises from 2 to 15 ring members.

According to a ninth aspect, the hollow-core optical fiber of any one of the sixth through eight aspects, wherein each ring member has a thickness of about 300 nm or greater.

According to a tenth aspect, the hollow-core optical fiber of the ninth aspect, wherein the thickness of each ring member is from about 300 nm to about 600 nm.

According to an eleventh aspect, the hollow-core optical fiber of any one of the sixth through tenth aspects, wherein adjacent ring members are separated by a gap that is about 1 micron or greater.

According to a twelfth aspect, the hollow-core optical fiber of the eleventh aspect, wherein the gap is from about 1 micron to about 10 microns.

According to a thirteenth aspect, the hollow-core optical fiber of any one of the sixth through twelfth aspects, wherein the radially inward-most ring member forms a central, hollow region.

According to a fourteenth aspect, the hollow-core optical fiber of any one of the first through thirteenth aspects, wherein each inner cladding member comprise an outer diameter of about 15 microns or greater.

According to a fifteenth aspect, the hollow-core optical fiber of the fourteenth aspect, wherein the outer diameter of each inner cladding member is from about 22 microns to about 80 microns.

According to a sixteenth aspect, the hollow-core optical fiber of any one of the first through fifteenth aspects, wherein each of the plurality of inner cladding members are spaced apart from each other by a distance of about 5.0 microns or less.

According to a seventeenth aspect, the hollow-core optical fiber of the sixteenth aspect, wherein the distance is from about 0.25 microns to about 5.0 microns.

According to an eighteenth aspect, the hollow-core optical fiber of any one of the first through seventeenth aspects, wherein the hollow-core optical fiber is configured to provide the single-mode propagation of the optical signal within the wavelength range from 800 nm to 2000 nm over a distance of about 2 m or more.

According to a nineteenth aspect, the hollow-core optical fiber of any one of the first through eighteenth aspects, wherein the hollow-core optical fiber is configured to provide the single-mode propagation of the optical signal within the wavelength range from 800 nm to 2000 nm over a distance of about 20 m or more.

According to a twentieth aspect, a hollow-core optical fiber comprising an outer cladding comprising a tubular shape with a hollow interior, a plurality of inner cladding members positioned with the hollow interior, and a hollow core formed by the plurality of inner cladding members, the hollow-core comprising a diameter of about 25.0 microns or less, and wherein a confinement loss of a single-mode of an optical signal propagating in the hollow-core optical fiber is less than or equal to 10⁻² dB/km within the wavelength range from 800 nm to 2000 nm.

According to a twenty-first aspect, the hollow-core optical fiber of the twentieth aspect, wherein the hollow-core optical fiber is configured to provide single-mode propagation of the optical signal within the wavelength range from 800 nm to 2000 nm.

According to a twenty-second aspect, the hollow-core optical fiber of the twentieth or the twenty-first aspects, wherein the diameter of the hollow core is about 20.0 microns or less.

According to a twenty-third aspect, the hollow-core optical fiber of any one of the twentieth through twenty-second aspects, wherein a bending loss of the single-mode of the optical signal propagating in the hollow-core optical fiber is less than or equal to 0.1 dB/km at the wavelength range from 800 nm to 2000 nm for a bend radius of 3 cm to 20 cm.

According to a twenty-fourth aspect, the hollow-core optical fiber of any one of the twentieth through twenty-third aspects, wherein the plurality of inner cladding members each comprises a plurality of ring members, the plurality of ring members each comprising a glass member separated from adjacent ring members by a gap.

According to a twenty-fifth aspect, the hollow-core optical fiber of the twenty-fourth aspect, wherein the plurality of ring members comprises a plurality of concentric rings.

According to a twenty-sixth aspect, the hollow-core optical fiber of the twenty-fourth or twenty-fifth aspects, wherein each inner cladding member comprises from 2 to 15 ring members.

According to a twenty-seventh aspect, the hollow-core optical fiber of any one of the twenty-fourth through the twenty-sixth aspects, wherein each ring member has a thickness of about 300 nm or greater.

According to a twenty-eighth aspect, the hollow-core optical fiber of the twenty-seventh aspect, wherein the thickness of each ring member is from about 300 nm to about 600 nm.

According to a twenty-ninth aspect, the hollow-core optical fiber of any one of the twenty-fourth through twenty-eighth aspects, wherein adjacent ring members are separated by a gap that is about 1 micron or greater.

According to a thirtieth aspect, the hollow-core optical fiber of the twenty-ninth aspect, wherein the gap is from about 1 micron to about 10 microns.

According to a thirty-first aspect, the hollow-core optical fiber of any one of the twenty-fourth through thirtieth aspects, wherein the radially inward-most ring member forms a central, hollow region.

According to a thirty-second aspect, the hollow-core optical fiber of any one of the twentieth through thirty-first aspects, wherein each inner cladding member comprise an outer diameter of about 15 microns or greater.

According to a thirty-third aspect, the hollow-core optical fiber of the thirty-second aspect, wherein the outer diameter of each inner cladding member is from about 22 microns to about 80 microns.

According to a thirty-fourth aspect, the hollow-core optical fiber of any one of the twentieth through thirty-third aspects, wherein each of the plurality of inner cladding members are spaced apart from each other by a distance of about 5.0 microns or less.

According to a thirty-fifth aspect, the hollow-core optical fiber of the thirty-fourth aspect, wherein the distance is from about 0.25 microns to about 5.0 microns.

It will be apparent to those skilled in the art that various modifications and variations can be made to the embodiments described herein without departing from the spirit and scope of the claimed subject matter. Thus, it is intended that the specification cover the modifications and variations of the various embodiments described herein provided such modification and variations come within the scope of the appended claims and their equivalents.

1. A hollow-core optical fiber comprising:
an outer cladding comprising a tubular shape with a hollow interior; and
a plurality of inner cladding members positioned with the hollow interior; and
a hollow core formed by the plurality of inner cladding members,
wherein the hollow-core optical fiber is configured to provide single-mode propagation of an optical signal within a wavelength range from 800 nm to 2000 nm.

2. The hollow-core optical fiber of claim 1, wherein the hollow core comprises a diameter of about 25.0 microns or less.

3. The hollow-core optical fiber of claim 1, wherein a confinement loss of the single-mode of the optical signal propagating in the hollow-core optical fiber is less than or equal to 10⁻² dB/km within the wavelength range from 800 nm to 2000 nm.

4. The hollow-core optical fiber of claim 1, wherein a bending loss of the single-mode of the optical signal propagating in the hollow-core optical fiber is less than or equal to 0.1 dB/turn at the wavelength range from 800 nm to 2000 nm for a bend radius of 3 cm to 20 cm.

5. The hollow-core optical fiber of claim 1, wherein the plurality of inner cladding members each comprises a plurality of ring members, the plurality of ring members each comprising a glass member separated from adjacent ring members by a gap.

6. The hollow-core optical fiber of claim 5, wherein the plurality of ring members comprises a plurality of concentric rings.

7. The hollow-core optical fiber of claim 5, wherein each inner cladding member comprises from 2 to 15 ring members.

8. The hollow-core optical fiber of claim 5, wherein each ring member has a thickness of about 300 nm or greater.

9. The hollow-core optical fiber of claim 8, wherein the thickness of each ring member is from about 300 nm to about 600 nm.

10. The hollow-core optical fiber of claim 5, wherein the gap is about 1 micron or greater in length.

11. The hollow-core optical fiber of claim 10, wherein the gap is from about 1 micron to about 10 microns in length.

12. The hollow-core optical fiber of claim 5 wherein the radially inward-most ring member forms a central, hollow region.

13. The hollow-core optical fiber of claim 1, wherein each inner cladding member comprise an outer diameter of about 15 microns or greater.

14. The hollow-core optical fiber of claim 1, wherein each of the plurality of inner cladding members are spaced apart from each other by a distance of about 5.0 microns or less.

15. The hollow-core optical fiber of claim 1, wherein the hollow-core optical fiber is configured to provide the single-mode propagation of the optical signal within the wavelength range from 800 nm to 2000 nm over a distance of about 2 m or more.

16. The hollow-core optical fiber of claim 1, wherein the hollow-core optical fiber is configured to provide the single-mode propagation of the optical signal within the wavelength range from 800 nm to 2000 nm over a distance of about 20 m or more.

17. A hollow-core optical fiber comprising:
an outer cladding comprising a tubular shape with a hollow interior; and
a plurality of inner cladding members positioned with the hollow interior; and
a hollow core formed by the plurality of inner cladding members, the hollow-core comprising a diameter of about 25.0 microns or less,
wherein a confinement loss of a single-mode of an optical signal propagating in the hollow-core optical fiber is less than or equal to 10⁻² dB/km within the wavelength range from 800 nm to 2000 nm.

18. The hollow-core optical fiber of claim 17, wherein the hollow-core optical fiber is configured to provide single-mode propagation of the optical signal within the wavelength range from 800 nm to 2000 nm.

19. The hollow-core optical fiber of claim 17, wherein the diameter of the hollow core is about 20.0 microns or less.

20. The hollow-core optical fiber of claim 17, wherein a bending loss of the single-mode of the optical signal propagating in the hollow-core optical fiber is less than or equal to 0.1 dB/turn at the wavelength range from 800 nm to 2000 nm for a bend radius of 3 cm to 20 cm.
